(19) United States
(12) Patent Application Publication
(10) Pub. No.: US 2011/0099237 A1
(43) Pub. Date: Apr. 28, 2011

(54) SYSTEM FOR OPERATING A SOCIAL NETWORK AND METHOD THEREFOR

(76) Inventor: Kfir Luzzatto, Omer (IL)

(21) Appl. No.: 12/908,908

(22) Filed: Oct. 21, 2010

Related U.S. Application Data
(60) Provisional application No. 61/254,455, filed on Oct. 23, 2009.

(51) Int. Cl. G06F 15/16

(52) U.S. Cl. 709/206

(57) ABSTRACT

A system for generating and managing messages in a social network comprises a virtual user suitable to generate messages in a thread.

### REFERENCE TO CO-PENDING APPLICATIONS

Priority is claimed to U.S. provisional patent application No. 61/254,455, filed on Oct. 23, 2009.

### FIELD OF THE INVENTION

The present invention relates to an improved system useful to operate a social network, and to a method of operating same.

### BACKGROUND OF THE INVENTION

Social networks have become important tools both for the purpose of exchanging information between their members and as means of communication between them. At the time of filing of the present application one of the most active social networks is Facebook, which declares having more than 500 million active users. Other social networks, such as, for instance, MySpace and Linkedin, also attract a large number of users, which has facilitated the exchange of information globally, without limitation.

One of the most important features of such networks relates to the ability of any given active user to start a discussion, hereinafter referred to as “thread”, which prompts other users to respond and contribute information of relevance to the question discussed in the thread. However, a substantial proportion of such threads is not taken up by other users and therefore never develops beyond the basic post made by the first user. This results in a disappointing user experience, and in many cases conversations that may lead to information of value to the members of the particular social network may not develop because of this fact.

It is therefore clear that it would be advantageous to provide means to ensure that threads are developed at least to some extent that may make them gain the attention of other active users, thus prompting them to participate and to contribute information beneficial to other active users. Furthermore, it is desirable to be able to generate new threads automatically, which may enrich the user experience of members of a social network.

It is an object of the present invention to provide a system that can be used to overcome the aforesaid problems. It is another object of the invention to provide a system and method to improve the user experience of active members of a social network. Other objects and advantages of the invention will become apparent as the description proceeds.

### SUMMARY OF THE INVENTION

In one aspect, the present invention relates to a system for generating and managing messages in a social network, said messages being attributed to a virtual user.

In another aspect the invention relates to a social network that comprises, or is coupled to a system for generating social messages attributable to a virtual user.

The invention also encompasses a method for providing an improved user experience to a user in a social network, comprising generating a virtual user which, through the application of appropriate hardware, software tools and analytical tools, is capable of analyzing strings of characters representing statements in natural language and to generate a response that is relevant to them.

### BRIEF DESCRIPTION OF THE DRAWINGS

FIG. 1 is an example of the events taking place in a social network, taken from the Facebook example page that appears on three physical pages—FIG. 1a is the first page, FIG. 1b is the second page, and FIG. 1c is the third page.

### DETAILED DESCRIPTION OF THE INVENTION

While the description to follow will rely on Facebook as the representative social network, which operates over the Internet, it should be understood that the invention is not limited to any particular social network or type of social network, or to any particular medium used to operate it. Thus, for example, social networks operated using a cellular network or a Local Area Network, or any other type of cooperative communication means, can benefit from the advantages of the present invention and are intended to be encompassed by it.

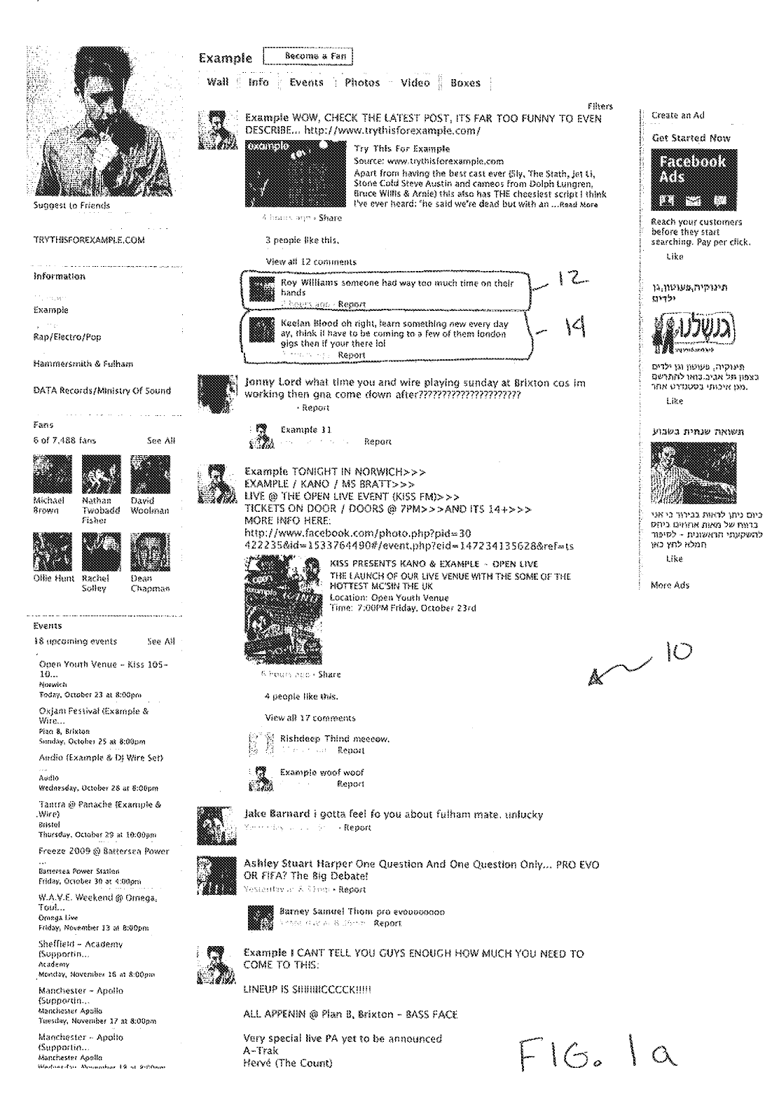

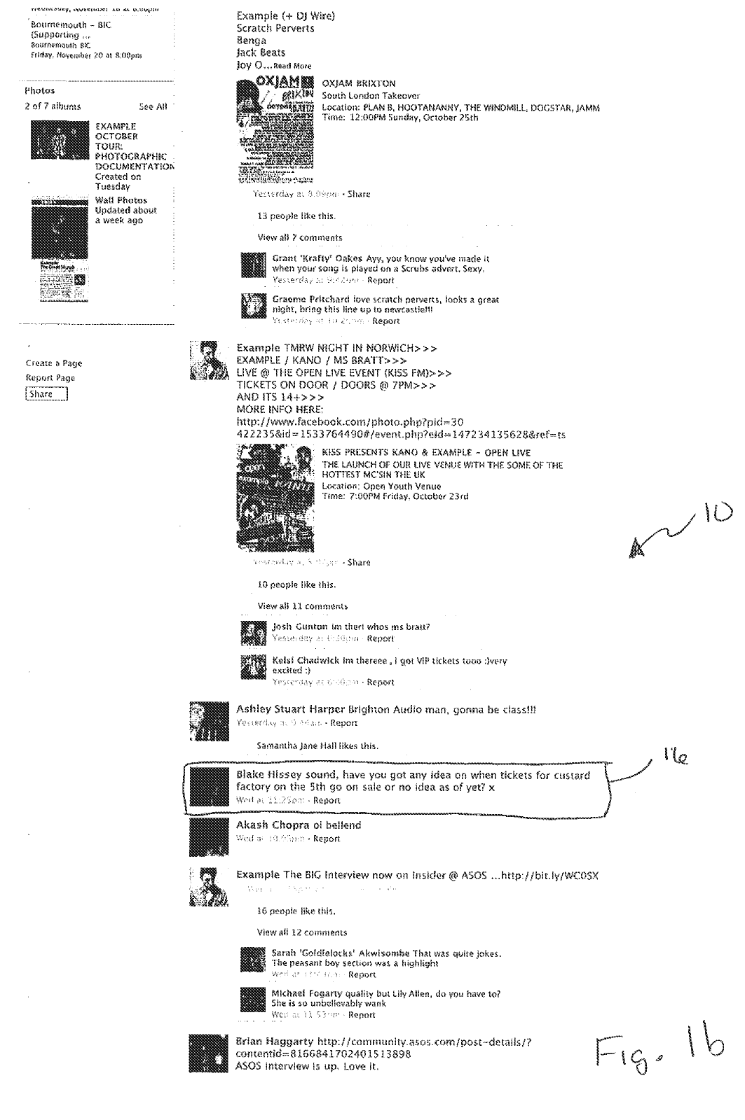

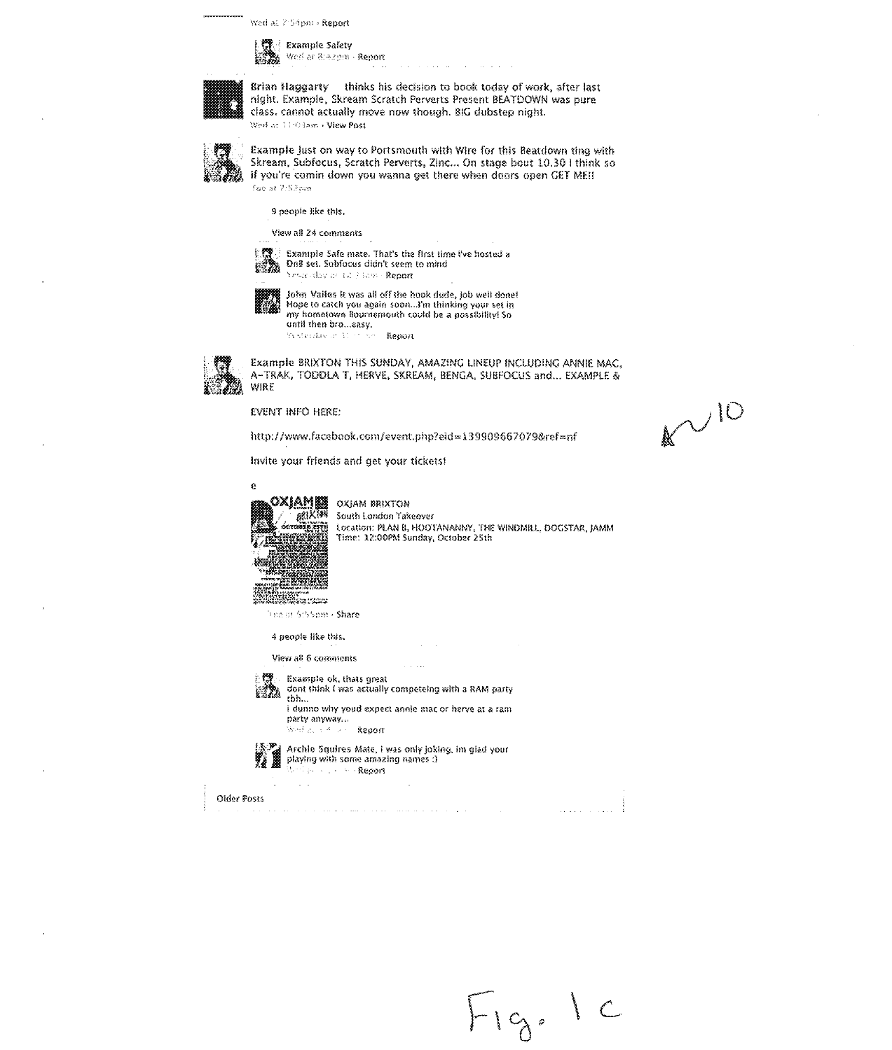

FIG. 1 is an example of a Facebook page 10, taken from the example pages of the website. This page illustrates how a thread is initiated. For instance, the first thread initiated by the user called “Example” was responded to by 12 people, and the first two (Roy Williams (12) and Keelam Blood (14)) are shown on FIG. 1a. On the other hand on the second page (FIG. 1b) of this example it can be seen that the user Blake Hissey 16 has posted a question regarding when tickets for a particular show are on sale, but this thread has not been picked up by any other user and no response has been made to it.

According to the invention a system is provided by which a user can generate one or more virtual active users of his social network, who will “respond” to a post initiated by the user, when certain conditions are met, such as, for example, if a certain amount of time has passed from the time the user posted the new thread without any response having been made. The above result is accomplished by providing a system that acquires the words of the thread posted on the social network and analyzes them using natural language analysis tools known in the art per se, and then generates a response relevant to the meaning of the words posted and continues the thread by posting the response that was so generated. The above result can be accomplished in a great variety of ways and one such way will be illustrated by a specific example detailed below.

Still referring to FIG. 1, let's assume that the user named “Example” has generated a virtual user by the name of Roy Williams. According to this particular example the system of the invention allows the user to generate a virtual user having certain characteristics, such as an image to be posted, the virtual user's character including, for instance whether the responses it generates will be serious or facetious, whether he will use particular tools to generate his response, such as looking for up-to-date information in Google, as well as any other variation and definition that may have an influence on the type, quality and length of the response that the virtual character will generate. Now, in his first post Example has waited for two hours with no response coming from any other active user, at which time Roy Williams, who appears to have been defined as a virtual character with cynical inclination, “responded” stating “someone had way too much time on their hands”. Roy's response attracts the attention of Keelan Blood, who in this example is not a virtual character, and the thread develops with 12 comments.

The activity that has taken place to permit the above includes:
providing a server equipped with software to acquire and analyze natural language statements;
identifying a string of characters belonging to the user and its characteristics and determining whether a predefined virtual character should respond, and when. This is further complicated in cases in which the user has predefined more than one virtual character;
generating a response pertinent to the matter which is the subject of the string of characters, with or without acquiring information from outside sources; and
posting the response in the pertinent thread.

The above steps all present technological challenges, which however can be met using hardware and analytical methods known in the art, adapted to perform the steps required by the invention. Thus, the invention relates not only to a system comprising hardware external to the social network and operating in parallel to it, but said hardware and analytical tools may be incorporated in the social network itself, if so desired.

In the examples above reference has been made to the virtual user responding to a thread initiated by a real user. However, of course the virtual user is not limited to responding to the original thread, but may also respond after responses have been made by other active users, and may also acquire such responses, analyze them and take them into account in its own response. Furthermore, the virtual user may also initiate a thread, and is not limited only to responding to an existing one.

Lastly, although the primary concern of the invention is to improve the exchange of information and the extent of communication by priming active users to join a given thread and participate in it, another goal that is achieved by the invention is to make the social network also a venue for enhanced entertainment, because various schemes and games can be devised, which exploit the intervention of virtual users in an environment used by active users. For instance, games can be designed, which pit virtual users in competition against one another, to achieve a desired conclusion, starting from a given thread. Thus, for instance, two active users could initiate threads including statements designed to guide each his own virtual user towards a predetermined conclusion, whereby the virtual user who responds with the desired response is the winner in the competition.

As will be appreciated by the skilled person, combining virtual users and real users in social networks presents a host of possibilities to enhance, enrich and improve the user experience that can be derived from the social network, as well as the level of information and communication among the real users that can be achieved by the inputs given by the system of the invention, in a manner closely resembling inputs from a human user, rather than from a machine.

All the above description and examples have been given for the purpose of illustration and are not meant to limit the invention in any way. As will be apparent to the skilled person, providing a virtual user in a social network can be accomplished and used in a variety of ways, all of which form part of the present invention.

1. A system for generating and managing messages in a social network, comprising a virtual user suitable to generate messages in a thread.

2. A system according to claim 1, wherein said virtual user comprises, or is coupled to, natural language analyzing circuitry.

3. A system according to claim 1, wherein said virtual user is provided with data suitable to impart a character to its messages.

4. A social network that comprises, or is coupled to a system for generating social messages attributable to a virtual user.

5. A social network according to claim 4, wherein the virtual user can be generated by selecting appropriate characteristics, so as to be prima facie undistinguishable from a real user as far as its message in a thread are concerned.

6. A method for improving user experience in a social network, comprising generating a virtual user which, through the use of appropriate hardware, software tools and analytical tools, is capable of generating a message that is relevant to the network.

7. A method according to claim 6, wherein the virtual user is capable of analyzing strings of characters representing statements in natural language and to generate a response that is relevant to them.

8. A method according to claim 6, wherein the hardware comprises computer apparatus.

9. A method according to claim 6, wherein the software tools and/or the analytical tools comprise natural language analysis tools.
